(19) United States
(12) Patent Application Publication
(10) Pub. No.: US 2010/0000229 A1
(43) Pub. Date: Jan. 7, 2010

(54) THERMOELECTRIC REFRIGERATING DEVICE

(76) Inventors: Patrick Arthur Tindale, Ruddington (GB); Stuart Peter Redshaw, Ratcliffe on Soar (GB)

Correspondence Address: Clise, Billion & Cyr, 605 US Hwy 169 North, Suite 300, Plymouth, MN, 55441, US

(21) Appl. No.: 12/514,137

(22) PCT Filed: Nov. 8, 2007
(86) PCT No.: PCT/GB07/04271

§ 371 Date: May 8, 2009

(51) Int. Cl. F25B 21/02; B23P 11/00

(52) U.S. Cl. 62/3.6; 29/428

(57) ABSTRACT

A thermoelectric refrigerator apparatus (20) comprising a thermoelectric device (1) having an upper face (1a) and a lower face (1b), a sealed cavity (22) for containment of a heat transfer liquid (8) in direct thermal contact with the upper face (1a) of the thermoelectric device (1)5 the cavity (22) being configured to allow convective flow (21) of the heat transfer liquid (8) from the upper face (1a) of the thermoelectric device (1) to an upper surface (12) of the cavity comprising a heat dissipation area (12) so as to transport heat from the lower face (1b) to an external environment via the heat dissipation area (12), wherein the thermoelectric device (1) is at least partially encapsulated by an encapsulating medium (2) providing a fluid seal around a perimeter edge (7) of the thermoelectric device (1) between the upper and lower faces (1a, 1b).

### FIELD OF THE INVENTION

The invention relates to the use of thermoelectric (or peltier) devices in thermoelectric refrigerating assemblies, and to methods for making such assemblies.

### BACKGROUND

Thermoelectric devices are well known from the prior art. Such devices, also known as Peltier devices, are solid state electrical heat pumps that transfer heat from one side of the device to the other when a voltage is applied. Peltier devices are mostly used for cooling, although they can also be used for heating when operated in reverse. Connecting a device to a DC voltage will cause one side to cool, while the other side warms. The effectiveness of such a device depends at least partly on how well heat from the hot side can be removed.

Thermoelectric devices are commonly assembled to form low cost cooling devices, and have well known drawbacks of low efficiency and a need for the use of fans. Technically, the most common configuration is in the form of a ‘thermoelectric stack’ comprising a spreader plate of solid conductive material coupled to a cold side of the thermoelectric device, a solid metal fined heat sink coupled to the hot side of the thermoelectric device, and a fan for dissipating heat from the heat sink.

A limitation of this technology has been found to be the amount of ‘waste heat’ that can be efficiently transferred through the heat sink and dissipated to ambient air. More advanced thermoelectric stacks have utilised a heat transfer fluid to remove heat from the thermoelectric device and then use a liquid-to-air heat exchanger for dissipation of the accumulated heat to ambient. In instances where liquid cooling is described, a pump is needed to transfer the heat transfer fluid to a heat dissipation area of the heat exchanger.

Of the liquid cooling solutions, two distinct techniques are currently known. The first uses a hollow, typically aluminum, heat exchanger that contacts with the surface of the thermoelectric device. In this configuration heat is transferred through the contact surface of the heat exchanger and then to the heat transfer fluid. The second type of fluid cooling circuit uses a similar heat exchanger except that the contact surface is removed so that heat transfer fluid can contact directly with a surface of the thermoelectric device. Thermally this method is superior but is technically more difficult due to the difficulty of making an effective seal.

Typically thermoelectric cooling devices may be sealed with either an o-ring or sealing gasket to prevent leakage. However, to ensure an effective seal the contact pressure required can exceed the mechanical strength of the device and can cause failures. In addition, commercially available thermoelectric devices are effective over almost their entire surface area. There is typically less than 2 mm around the edge of a thermoelectric device where cooling is not required. If a gasket is misaligned so that a small area of the thermoelectric device is not cooled then there is a high likelihood of thermal runaway and failure. For this reason, direct contact type heat exchangers are relatively unusual although still commercially available.

It is an object of the invention to address one or more of the above mentioned problems.

### SUMMARY OF THE INVENTION

In a first aspect, the invention provides a thermoelectric refrigerator apparatus comprising:
a thermoelectric device having an upper face and a lower face;
a sealed cavity for containment of a heat transfer liquid in direct thermal contact with the upper face of the thermoelectric device, the cavity being configured to allow convective flow of the heat transfer liquid from the upper face of the thermoelectric device to an upper surface of the cavity comprising a heat dissipation area so as to transport heat from the lower face to an external environment via the heat dissipation area,
wherein the thermoelectric device is at least partially encapsulated by an encapsulating medium providing a fluid seal around a perimeter edge of the thermoelectric device between the upper and lower faces.

In a second aspect, the invention provides a method of making a thermoelectric refrigerator apparatus, the method comprising:
providing a thermoelectric device having an upper face and a lower face;
positioning the device in a mould having an upper part and a lower part adjacent to the upper and lower faces of the device respectively, a volume surrounding a perimeter edge of the device being defined between the upper and lower parts of the mould;
filling the volume with an liquid encapsulating medium;
solidifying the encapsulating medium;
separating the upper and lower parts of the mould to release the encapsulated thermoelectric device,
wherein the thermoelectric device is at least partially encapsulated by an encapsulating medium providing a fluid seal around a perimeter edge of the thermoelectric device between the upper and lower faces.

The technological advances described herein are intended to improve the operation and efficiency of thermoelectric refrigeration by significantly improving the method of dissipating waste heat, and facilitating the removal of all moving parts such as fans or pumps from the thermoelectric refrigeration apparatus.

There are at least three advantageous aspects to the invention. The first is allowing a heat transfer fluid to contact directly with the upper surface of a thermoelectric cooling device. The second is enabling mass transfer of the heat transfer fluid from the upper surface of the thermoelectric cooling device to a heat dissipating region without the need for a pump. The third relates to the heat dissipating region of the apparatus being configured to function without fans to remove heat to ambient. Together or separately, these three advantages enable thermoelectric cooling devices to operate more efficiently without the need for moving parts such as fans or pumps.

### DETAILED DESCRIPTION

The invention will now be described by way of example, and with reference to the enclosed drawings in which:

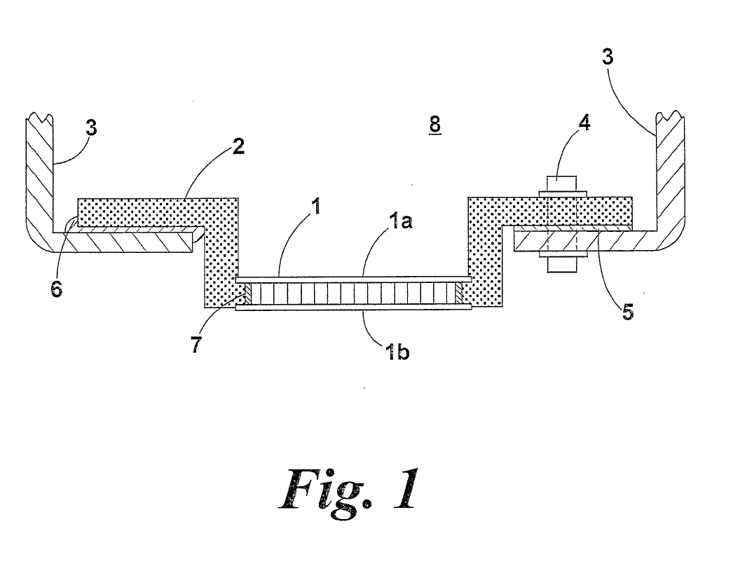

FIG. 1 shows a schematic cross-sectional view through a part of the thermoelectric refrigerator apparatus;

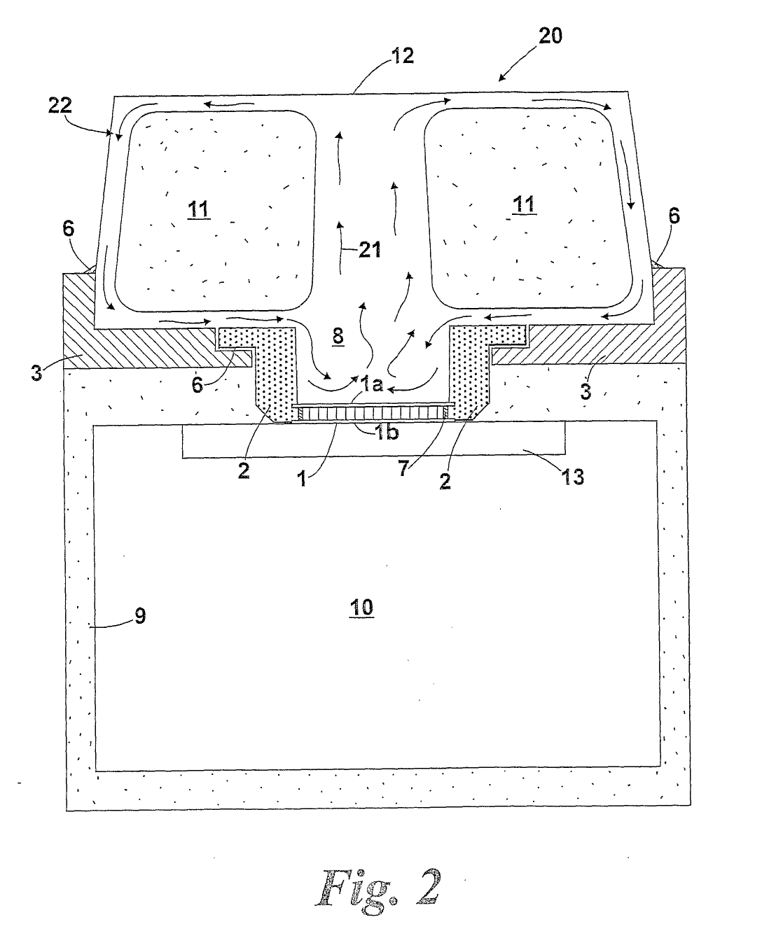

FIG. 2 shows a schematic cross-sectional view of an exemplary thermoelectric refrigerator apparatus;

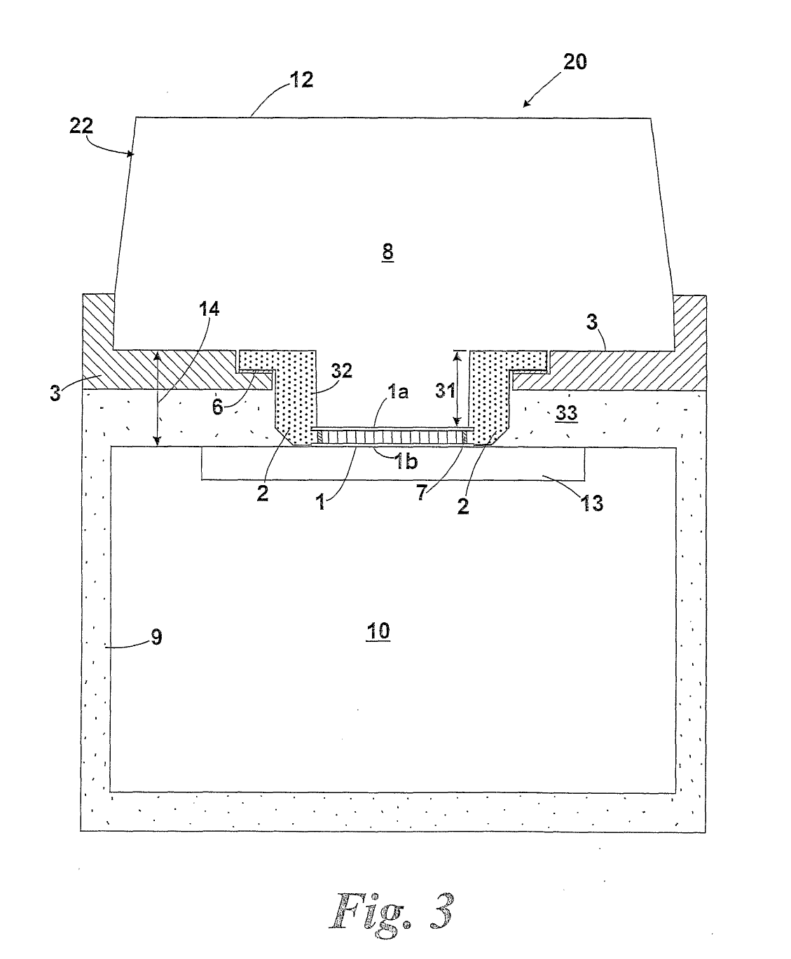

FIG. 3 shows a schematic cross-sectional view of a further exemplary thermoelectric refrigerator apparatus; and

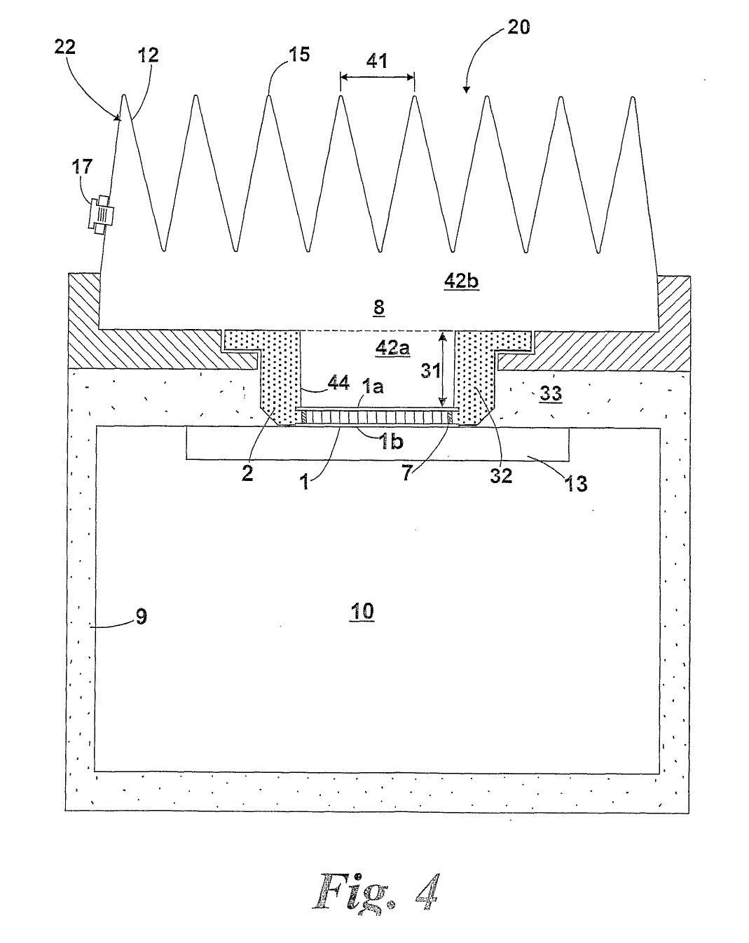

FIG. 4 shows a schematic cross-sectional view of a further exemplary thermoelectric refrigerator apparatus.

Various features associated with aspects of the invention can be used to enable a heat transfer liquid to safely and reliably contact the surface of a thermoelectric device, and also facilitate the movement of heat transfer liquid via convection to an area where heat can be dissipated to ambient, without the use of either a circulating pump or a cooling fan thereby removing parts that may require regular maintenance and require power to operate.

One feature relates to a method of encapsulating the thermoelectric cooling device, also referred to as a peltier device. This technique allows the peltier device to be safely clamped or bonded to form part of the thermoelectric refrigerating apparatus. The process avoids placing undue mechanical stress on the peltier device, allowing heat transfer liquid to directly contact the upper surface of the peltier device, which is typically composed of a ceramic plate. In cases where the heat transfer liquid may not be compatible with the materials used in the construction of the peltier device, a thin barrier layer of encapsulating material can be used over the upper and/or lower surfaces of the peltier device.

The encapsulation technique may also incorporate a ‘chimney’ in the form of a wall made from an impermeable material extending upwards from a perimeter edge of the peltier device. The chimney allows for a separation of a hot upper portion of the thermoelectric refrigerator apparatus, including the heat transfer liquid and heat dissipation area, from a cooler lower portion, including the lower face of the peltier device and a component or volume to be cooled. This feature significantly improves the cooling efficiency of the thermoelectric refrigerating device by allowing insulation to be placed between the hot and cold zones, i.e. in a space defined between the sealed cavity containing the heat transfer liquid and the lower face of the thermoelectric device.

A second feature is the inclusion of a flow splitter to encourage and enhance the mass transfer of the heat transfer fluid with only thermal convection as the driving mechanism. The flow splitter occupies a volume within the sealed cavity, and therefore reduces the required quantity of heat transfer liquid, which can reduce weight and cost.

A third feature concerns a method of dissipating the accumulated heat in the heat transfer liquid to ambient without a fan. In the first instance this is achieved through a simple assembly comprising of thin sheet aluminum or equivalent material which is folded or corrugated in a concertina like fashion to have the necessary surface area for natural convection to ambient. However, the inventors recognise that there are many ways to provide a heat dissipation surface including casting and pressing techniques which may also fall within the scope of the invention. Various methods can be used to incorporate such heat dissipation structures into the main body of the unit to form the sealed cavity, such as casting the structure into a thermally conductive epoxy resin. In manufacture the encapsulated thermoelectric device could be bolted or even simply glued into position and the sealed cavity thereby formed subsequently filled with a suitable heat transfer fluid.

Exemplary thermoelectric refrigerating apparatuses described herein have been constructed and tested by the inventors. In these tests the thermoelectric device has given similar, if not better, performance to a good quality commercially available fan cooled thermoelectric device but with greater than 30 percent less power consumption and no moving parts. The key benefit of the removal of moving parts is in the greatly increased system reliability and totally silent operation. In addition, the above technical advances are scalable from very small thermoelectric systems (as would be applied to a computer chip) through to very large thermoelectric systems that would require the use of a fan cooled liquid-to-air heat exchanger and pump system.

Specific exemplary embodiments are illustrated in FIGS. 1 to 4. FIG. 1 shows a cross section through an encapsulated thermoelectric device 1. The thermoelectric device 1 in this instance has been cast into an encapsulating medium, forming an encapsulating structure 2. Exemplary materials for this purpose are epoxy or polyurethane resin, typically being formed from chemical reaction of a two-part liquid mixture, resulting in polymerisation and solidification. The encapsulated thermoelectric device 1 is thus provided with a structure 2 adapted for attachment to an enclosure 3, the structure 2 and enclosure 3 together defining a sealed cavity 8 that can be filled with a heat transfer liquid. Attachment of the encapsulating structure 2 to the enclosure 3 may be made by means of one or more bolts 4 and a gasket or o-ring seal 5, and/or by use of a jointing compound or adhesive 6.

Through the arrangement shown in FIG. 1, the thermoelectric device 1 can be hermetically sealed around an edge 7 of the device 1 by the encapsulating structure 2, which provides an area where the encapsulating structure 2 can be bolted or bonded on to a larger structure, i.e. the enclosure 3, without undue stress being applied to the thermoelectric device.

The inventors have found that a barrier material applied to the perimeter edge 7 of the thermoelectric device, can prevent the encapsulating material from entering the inner parts of the thermoelectric device and reducing performance. This barrier material may be present in commercially available sealed thermoelectric devices, where some degree of water prooffiess is required.

To assemble the unit comprising the thermoelectric device 1 and encapsulating structure 2, a moulding method such as reaction injection moulding may be used. Other methods such as conventional plastic injection moulding may be alternatively used. A mould having two or more parts is made, an upper part defining the upper surface of the encapsulating structure and a lower part defining the lower surface. The thermoelectric device 1 is positioned within the mould and the two parts brought together either side of the device 1, with the upper part adjacent to or in contact with the upper face 1 a of the device 1 and the lower part adjacent to or in contact with the lower face 1b of the device 1. Any wires attached to the device 1 are threaded through holes in the mould. The mould is clamped together and a pre-mixed liquid mixture of two-part resin is introduced through a throat in the mould. A suitable exemplary resin is a two-part polyurethane. Once the resin is at least partially set, the mould can be separated and the encapsulating structure 2 and device 1 removed. Once curing is completed, the unit 1, 2 can be assembled with the other components of the thermoelectric refrigerating apparatus.

FIG. 2 shows a cross section through an exemplary thermoelectric refrigerating apparatus after assembly is complete. In this arrangement, flow separators 11 are included. A sealed cavity 22, in which the flow separators 11 are placed, is filled with a heat transfer liquid 8. An exemplary heat transfer liquid is distilled water, preferably including an additive such as a glycol to prevent corrosion and/or freezing. Many other fluids could be selected, depending on the particular application. In operation, the thermoelectric device 1 increases the temperature of liquid in direct physical contact with the upper surface 1a of the device 1. This heating causes the heat transfer liquid 8 to expand and become relatively less dense. The flow separators 11 then encourages this heated and buoyant liquid to rise. This upward flow, indicated by flow arrows 21, promotes a circulating convective flow pattern that presents the hot heat transfer fluid 8 to the inside skin of the heat dissipation area 12 of the sealed cavity 22.

The heat dissipation area 12 is preferably formed of a thin sheet material, such as aluminium of 0.2 to 0.3 mm in thickness. The necessary surface area for heat dissipation to ambient may be provided by folding the sheet metal in a concertina-like fashion. The heat dissipation area 12 is then clamped, bolted or bonded to the rest of the enclosure 3, for example through use of an adhesive 6.

FIG. 2 also shows the functional elements of the entire thermoelectric refrigerating apparatus 20. These elements may comprise a temperature controlled volume 10 surrounded by an insulating material 9, forming a thermally insulated enclosed volume in thermal communication with the lower face 1b of the thermoelectric device 1 so as to transport heat from the volume 10 to the external environment via the heat dissipation area 12.

Other components for transferring heat from the volume 10 to the cold lower surface lb of the thermoelectric device 1 may include a metal spreader plate 13, which may be composed of a solid piece of metal such as aluminum, although various other methods such as heat pipes or thermosiphons may be used. These techniques are well known in the prior art and the spreader plate illustrated 13 is given as an example only.

Certain elements of the apparatus shown in FIG. 2 from the thermoelectric device upwards, i.e. at least the device itself 1, the encapsulating structure 2 and the sealed cavity 22, can also be used to cool other objects by attachment of the lower surface 1b of the thermoelectric device 1 to the object. Such an alternative object may, for example, include an integrated circuit package.

The spreader plate 13 illustrated could optionally be replaced with a heat pipe or a thermosiphon in thermal communication with the lower surface 1b of the thermoelectric device, configured and arranged to extract heat from the thermally insulated volume 10.

FIG. 3 shows how the ‘chimney’ shape of the encapsulated thermoelectric unit 1, 2, enables the hotter upper surface 1a of the device 1 to be separated from the colder lower parts 1b, 13. The amount of separation required, indicated by arrow 14, depends on each application, although chimney heights of between 30 and 40 mm have been found to give optimum insulating characteristics without unduly impeding the convective flow mechanism in the sealed cavity 22. The amount of separation may be conveniently defined by the vertical separation of an upper portion of the sealed cavity 22 from the upper face 1a of the thermoelectric device 1, as indicated by the dimension 31 shown in FIG. 3. This dimension determines the space 33 available between the perimeter wall 32 of the encapsulating structure and the lower face 1b of the thermoelectric device 1. The space 33 is preferably filled with a thermally insulative material, such as a rigid closed-cell foam material. The rigid closed cell foam material may also comprise the insulated enclosure 9 defining the temperature controlled volume 10.

FIG. 4 shows the heat dissipation area 12 in a preferred configuration. The heat dissipation area is preferably formed from a sheet of metal, although plastic materials may be used. In a preferred embodiment, the heat dissipation area is formed of thin sheet material, typically aluminum of 0.2-0.3 mm thickness. The necessary surface area for heat dissipation to ambient can be provided by deforming the sheet material, for example by folding the sheet metal in a concertina-like fashion. This increases the interfacial area between the heat transfer liquid and an inner surface of the heat dissipation area 12, without increasing the thermal path between the heat transfer liquid and the surrounding environment. The efficiency of heat transfer to the surrounding environment is thereby improved. The heat dissipation area may be deformed in other ways to achieve the same effect.

The inventors have found that the separation 41 between each fin 15 or peak across the heat dissipation area 12 has a significant effect on system performance. If insufficient surface area is provided, the outer surface exceeds an optimum working temperature. Increasing the surface area through a greater density of convolutions or corrugations improves the heat transfer to the surrounding environment. However, there is a critical density where heat transfer to ambient air of the external environment is impeded by the close spacing between peaks. The optimum spacing 41 has been found to be approximately between 10 and 25 mm, preferably between 15 and 25 mm, and optionally between 10 and 15 mm.

FIG. 4 also shows a filling point 17 for filling the sealed cavity 22 with heat transfer liquid 8. The heat transfer liquid preferably fills the entire internal volume of the sealed cavity 22. Changes in volume due to expansion of the heat transfer liquid as it is heated may be accommodated through slight deformation of the thin aluminum skin forming the heat dissipation area 12. For applications where further expansion is required, a bellows or compressible device such as a bladder can be incorporated into the sealed cavity 22.

The encapsulating structure 2 defines a lower portion 42a of a volume within the sealed cavity 22, an upper portion 42b being defined above the upper extent 43 of the perimeter wall 32. The section of the lower portion 42a, defined by the inner surface 44 of the perimeter wall 32, is reduced compared with the upper portion. This feature, by defining a space between the perimeter wall 32 of the encapsulating structure 2 and the lower face 1b of the thermoelectric device 1, facilitates thermal segregation of the upper and lower faces of the device 1. The lower portion 42a section may taper outwardly towards the upper portion 42b of the volume within the sealed cavity 22. This can aid the transition of convective flow from and to the upper surface 1a of the thermoelectric device 1. As for other exemplary embodiments, the height of the perimeter wall 32, as for example defined by the height 31 of the lower portion 42a, is preferably between 30 and 40 mm.

Alternative arrangements of the sealed cavity 22 and encapsulating structure 2 or ‘chimney’ may include the heat dissipation area 12 being oriented on a side face of the sealed cavity 22, providing that a sufficient vertical distance is maintained between the upper surface 1a of the thermoelectric device 1 and the heat dissipation area 12 for convection of the heat transfer liquid to occur. Such an alternative may, for example, be useful in applications in computer cases where heat needs to be transferred from a chip on the motherboard of the computer to the outside of the case. Alternatively, or additionally, the orientation of the thermoelectric device 1 may be away from horizontal as shown in the figures, and instead for example with the lower face 1b of the device 1 oriented vertically so as to be attached to a side face of an object to be cooled.

Other embodiments are intentionally within the scope of the invention as defined by the appended claims.

1. A thermoelectric refrigerator apparatus comprising:
a thermoelectric device having an upper face and a lower face;
a sealed cavity for containment of a heat transfer liquid in direct thermal contact with the upper face of the thermoelectric device, the cavity being configured to allow convective flow of the heat transfer liquid from the upper face of the thermoelectric device to an upper surface of the cavity comprising a heat dissipation area so as to transport heat from the lower face to an external environment via the heat dissipation area,
wherein the thermoelectric device is at least partially encapsulated by an encapsulating medium providing a fluid seal around a perimeter edge of the thermoelectric device between the upper and lower faces.

2. The thermoelectric refrigerator apparatus of claim 1 comprising an object in thermal communication with the lower face of the thermoelectric device so as to transport heat from the object to the external environment via the heat dissipation area.

3. The thermoelectric refrigerator apparatus of claim 2 wherein the object comprises an integrated circuit package.

4. The thermoelectric refrigerator apparatus of claim 2 wherein the object comprises a thermally insulated enclosed volume.

5. The thermoelectric refrigerator apparatus of claim 4 comprising a spreader plate attached to the lower surface of the thermoelectric device and configured to allow for heat transport from the volume to the lower surface of the thermoelectric device.

6. The thermoelectric refrigerator apparatus of claim 4 comprising one of a heat pipe and thermosiphon attached to the lower surface of the thermoelectric device and configured to allow for heat transport from the volume to the lower surface of the thermoelectric device.

7. The thermoelectric refrigerator apparatus of claim 1, comprising a perimeter wall extending upwardly from the sealed perimeter edge of the thermoelectric device, the perimeter wall defining a lower portion of the sealed cavity having a reduced section relative to an upper portion of the sealed cavity, the wall defining a space between the sealed cavity and the lower face of the thermoelectric device.

8. The thermoelectric refrigerator apparatus of claim 7 wherein the perimeter wall is composed of the encapsulating medium.

9. The thermoelectric refrigerator apparatus of claim 7 wherein the section of the lower portion tapers outwardly towards the upper portion of the sealed cavity.

10. The thermoelectric refrigerator apparatus of claim 7 wherein the space is at least partly occupied with a thermally insulative material.

11. The thermoelectric refrigerator apparatus of claim 1, wherein the heat dissipation area of the sealed cavity comprises convolutions of the upper surface of the cavity.

12. The thermoelectric refrigerator apparatus of claim 1, wherein the upper surface of the cavity is composed of a corrugated metal plate having a substantially uniform thickness.

13. The thermoelectric refrigerator apparatus of claim 12 wherein successive peaks across the heat dissipation area are spaced apart by a distance of between 10 mm and 25 mm.

14. The thermoelectric refrigerator apparatus of claim 1, wherein the sealed cavity is filled with a heat transfer liquid.

15. A method of making a thermoelectric refrigerator apparatus, the method comprising:
providing a thermoelectric device having an upper face and a lower face;
positioning the device in a mould having an upper part and a lower part adjacent to the upper and lower faces of the device respectively, a volume surrounding a perimeter edge of the device being defined between the upper and lower parts of the mould;
filling the volume with an liquid encapsulating medium; solidifying the encapsulating medium;
separating the upper and lower parts of the mould to release the encapsulated thermoelectric device,
wherein the thermoelectric device is at least partially encapsulated by an encapsulating medium providing a fluid seal around a perimeter edge of the thermoelectric device between the upper and lower faces.

16. The method of claim 15 wherein the upper and lower parts of the mould are in contact with the respective upper and lower faces of the thermoelectric device.

17. The method of claim 16 further comprising forming a sealed cavity for containment therein a heat transfer liquid in direct thermal contact with the upper face of the thermoelectric device, the cavity being configured to allow convective flow of the heat transfer liquid from the upper face of the thermoelectric device to an upper surface of the cavity comprising a heat dissipation area so as to transport heat from the lower face to an external environment via the heat dissipation area.

18. The method of claim 15 further comprising forming a sealed cavity for containment therein a heat transfer liquid in direct thermal contact with the upper face of the thermoelectric device, the cavity being configured to allow convective flow of the heat transfer liquid from the upper face of the thermoelectric device to an upper surface of the cavity comprising a heat dissipation area so as to transport heat from the lower face to an external environment via the heat dissipation area.

19. The thermoelectric refrigerator apparatus of claim 11, wherein successive peaks across the heat dissipation area are spaced apart by a distance of between 10 mm and 25 mm.

20. The thermoelectric refrigerator apparatus of claim 7, wherein the heat dissipation area of the sealed cavity comprises convolutions of the upper surface of the cavity, and wherein the upper surface of the cavity is composed essentially of a corrugated metal plate having a substantially uniform thickness.
